(19) United States
(12) Patent Application Publication
(10) Pub. No.: US 2011/0237465 A1
(43) Pub. Date: Sep. 29, 2011

(54) Release of Chemical Systems for Oilfield Applications by Stress Activation

(76) Inventors: Jesse Lee, Paris (FR); Stéphane Boulard, Le Plessis Robinson (FR); Nikhil Shindgikar, Paris (FR); Kefi Slaheddine, Velizy Villacoublay (FR)

(21) Appl. No.: 13/056,217

(22) PCT Filed: Jul. 30, 2009
(86) PCT No.: PCT/EP2009/005702

§ 371 Date: Jun. 8, 2011

(30) Foreign Application Priority Data
Aug. 18, 2008 (EP) 08290782.5

(51) Int. Cl. C09K 8/08

(52) U.S. Cl. 507/110

(57) ABSTRACT

The invention provides a system comprising a encapsulating material (B) and a component (A), wherein said component (A) is trapped within said encapsulating material (B) and said encapsulating material (B) being able to break and release said component (A) under pressure drop higher than 10 bars.

### FIELD OF THE INVENTION

The present invention broadly relates to oilfield applications. More particularly the invention relates to a method to release chemistry downhole in a subterranean reservoir, such as for instance oil and/or gas reservoir or a water reservoir.

### DESCRIPTION OF THE PRIOR ART

The statements in this section merely provide background information related to the present disclosure and may not constitute prior art.

For oilfield chemical systems, reactive components are often part of the design and most of time their reactivity needs to be delayed or suppressed until the right timing. This is mainly due to the different performance requirements at different stages of the pumping and placement. For example, a lost circulation pill should be low in viscosity during pumping and high in yield stress after the system is placed. The sudden change of property is traditionally controlled by temperature changes, mixing with other fluids or delaying agents. None of these methods are precise and accurate due to the uncertain nature of bottom hole conditions, thus certain degrees of assumption are always involved, and product performances are likely compromised.

The following invention describes a novel and alternative mechanism in regards to releasing reactive chemicals. Namely, utilizing solid materials that can be blended with the base fluids, and having their core materials released upon exposure to a trigger e.g. high shear and/or elongation flow. For example, fluids exiting the drill bits typically experience relatively high stress, thus, drill bits can be used as a mechanical trigger to release reactive materials and induce the desired property transformation.

### SUMMARY OF THE INVENTION

Chemical systems designed for oilfield application experience stress throughout the whole placement process. Some systems see relatively low stress, like cement, flowing inside the annulus; and some systems see relatively high stress, like mud, exiting the drill bit. As such, utilizing stress as a mechanism to control the properties of the chemical system exhibits minimum impact in terms of interfering with common operational procedures.

The invention disclosed herewith focuses on utilizing high stress, encountered by the chemical systems during the placement, as a trigger mechanism to control the release of reactive materials. Once the reactive material is released, then the properties of the whole chemical system can be altered and tailored to meet the performance criteria. Two general types of release systems are described. The first type is protecting the reactive material in a matrix, and the second type is encapsulating the reactive material inside capsules. High stress breaks the matrix and/or the capsule materials, allowing a release of the chemicals that can then react.

According to one aspect of the invention, it provides a system comprising an encapsulating material (B) and a component (A), wherein said component (A) is trapped within said encapsulating material (B) and said encapsulating material (B) being able to break and release said component (A); the system further comprises a carrier fluid (C) transporting said encapsulating material (B) and said trapped component (A), wherein said encapsulating material (B) is able to break and releases said component (A) under velocity difference of the carrier fluid (C) of more than 50 times. The system can further comprise a reactive component (R) present in said carrier fluid (C).

In a first alternative, the encapsulating material (B) is a solid matrix made of an inert material for component (A) and in a second alternative the encapsulating material (B) is a capsule made of an inert coating material for component (A).

According to another aspect of the invention, it provides a method to release a component (A) in a zone of a wellbore, comprising the steps of: placing an encapsulating material (B) and a component (A) in the wellbore, wherein said component (A) is trapped within said encapsulating material (B); placing said encapsulating material (B) and said trapped component (A) in a restriction in the vicinity of the zone so said encapsulating material (B) is able to break and releases said component (A). Preferably, the restriction creates velocity increases and/or decreases of at least 50 times variation.

Preferably, the step of placing said encapsulating material (B) is done by placing further a carrier fluid (C) transporting said encapsulating material (B) and said trapped component (A).

### BRIEF DESCRIPTION OF THE DRAWINGS

Further embodiments of the present invention can be understood with the appended drawings:

FIG. 1 shows the invention in a first type embodiment.

FIG. 2 shows the invention in a second type embodiment.

FIG. 3 shows the yield stress experiment result of the first type embodiment of the invention.

FIG. 4 shows the particle size distribution of the second type embodiment of the invention (d50, for example, stands for 50% of the particles have a diameter below the value next to it).

FIG. 5 shows a measurement of release of Type II system.

FIG. 6 shows a measurement of release of Type I system.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein may also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The present invention refers to a system made of an encapsulating material (B) and a component (A). The component (A) is trapped within the encapsulating material (B) and the encapsulating material (B) is able to break and release the component (A) under a trigger. The trigger is a sufficient stress such as the passage through a restriction, e.g. a perforation or a drill bit. Without being bound by any theory, the inventors believe that the combination of shear and elongational flow experienced in these conditions are producing enough stress to break the encapsulating material (B) and release the component (A). Basically, the stress might first come from the turbulence experienced in the pumps of surface equipment and within the carrier fluid (C) in itself; after that, the passage of the flow through a restriction creates first some sort of “Venturi effect” with an acceleration of the fluid which will have the effect of deforming the encapsulating material (B) and then at the outlet of the restriction another deformation of the encapsulating material (B) coming from fluid deceleration. Velocity increases and decreases are typically of the order of 50 to 100 times variation. Strain rates experienced in restriction are typically from 1 000 to one million reciprocal second, more specifically 10 000 to 200 000 reciprocal second. The inventors have noticed that even if the stress experienced during pumping and all along the transportation has an effect on the breakage of the encapsulating agent (B), the stress and/or velocity difference which is obtained due to the flow through a restriction is of paramount importance. The stress is closely related to the pressure drop encompassed in each units of the well treatment (pumps, pipes, drill-bit). A higher pressure drop corresponds to a higher stress applied. Typically, the highest stress is observed when the fluid passes through the nozzles in a drill bit or a port of completion string downhole. By stress sufficient to break the encapsulating agent (B), it has to be understood in the context of the present invention, that said sufficient stress is produced by the passage through the nozzles of the drill bit or similar restriction to allow the component (A) to be released from the encapsulating agent (B). Preferably, the pressure drop observed when passing through the nozzles is from about 150 to 5 000 psi (10 to 345 bar), more preferably from 300 to 5 000 psi (20 to 345 bar), most preferably from 300 to 1 000 psi (20 to 69 bar). As shown earlier, the stress may sometimes also be referred to as a velocity difference.

As apparent on FIG. 2, the encapsulating material (B) can be a flexible capsule made of gelatin, pectin, derivatives of cellulose, arabic gum, guar gum, locust bean gum, tara gum, cassia gum, agar, or n-octenyl succinated starch, porous starch, pectin, alginates, carraghenanes, xanthan, chitosan, scleroglucan, diutan and mixtures thereof. Good examples of suitable encapsulating technologies could be found in “Microencapsulation”, Vandamme T., Poncelet D., Subra-Paternault P., Lavoisier, Paris, 2007. In a preferred embodiment, the encapsulating material is a blend of gelatin and gum arabic. The ratio gelatin to gum Arabic is preferably from 9:1 to 1:9 parts by weight, preferably 5:1 to 1:5, more preferably 2:1 to 1:2 and most preferably about 1:1. The capsules and/or matrix according to the present invention preferably have a diameter (or main dimension) of from 1 to 5 000 microns, more preferably from 10 to 2 000 microns.

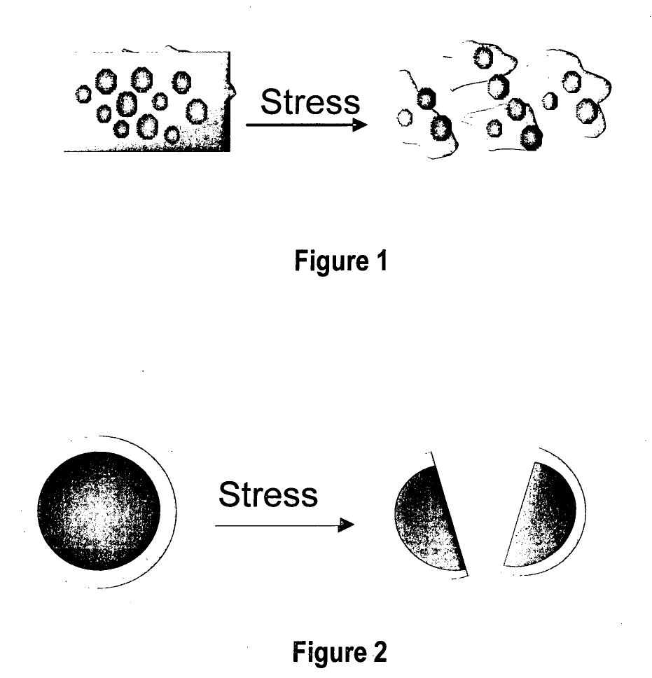

Also, as shown on FIG. 1, the encapsulating material (B) can be a solid matrix such as those made of organopolysiloxanes as described by Donnadieu et al. (U.S. Pat. No. 4,604,444). Other suitable material might be gelatin, polyurethane, or lattices, and mixtures thereof.

The system can be made of soft capsules and/or matrix that would be mostly sensitive to elongational flow or of rigid capsules and/or matrix that would be more sensitive to shear flow.

The component (A) can be any type of chemical components that do not react with the encapsulating agent (B) and can be made of a combination of a first, a second, a third or more chemical component.

The reactive component (R) can be any type of chemical components that do not react with the encapsulating agent (B) and can be made of a combination of a first, a second, a third or more reactive chemical component. Preferably, the component (A) and the reactive component (R) are able to react or mix when in contact.

Currently, two general types of encapsulating material have shown behavior of stress-releasing. FIG. 1 shows a first type (Type I) having a general structure of embedding material inside an inert matrix. The inert matrix is the encapsulating material and the material is the component. FIG. 2 shows a second type (Type II) having a general capsule like structure, i.e. the component is surrounded by an inert wall material made of the encapsulating material. The effectiveness of shear-releasing mainly depends on the physical and chemical properties of the inert wall or matrix materials.

The systems according to the invention can have various embodiments. In one aspect of the present invention, there are provided compositions with an encapsulated material (B), these compositions leading to polymer systems for drilling, completion, stimulation, production enhancement or remedial operations in subterranean zones penetrated by a borehole by initiating polymerization with a crosslinker.

In one embodiment, the system includes: a carrier fluid (C), a reactive component (A) being a polymer, and an encapsulated crosslinker (R) in the encapsulating material (B), and other additives, such as pH control agent, delaying agent, fillers, fluid loss agents, lubricating agents, biocides and other relevant additives for the specific application the system is used for.

In a second embodiment, the system includes: a carrier fluid (C), an encapsulated polymer (A) in the encapsulating material (B), a reactive component (R) being a crosslinker, and other additives, such as pH control agent, delaying agent, fillers, fluid loss agents, lubricating agents, biocides and other relevant additives for the specific application the system is used for.

In a third embodiment, the system includes: a carrier fluid (C), a first reactive component (A) being a polymer, a second reactive component (A) being a crosslinker, an encapsulated crosslinking activator (R) in the encapsulating material (B), and other additives, such as pH control agent, delaying agent, fillers, fluid loss agents, lubricating agents, biocides and other relevant additives for the specific application the system is used for.

In a fourth embodiment, the system includes: a carrier fluid (C), a combination of polymer (A) or crosslinker (A) or activator (R) encapsulated in a single or several capsules (B) or solid matrix (B), and other additives, such as pH control agent, delaying agent, fillers, fluid loss agents, lubricating agents, biocides and other relevant additives for the specific application the system is used for.

In all of these embodiments, the carrier fluid can be water-based, solvent-based or oil-based. The polymer can be a polysaccharide such as guar and its derivatives, cellulose and its derivatives, xanthan, wellan, scleroglucan, chitosan, diutan and other polysaccharides used as gelling agents, a synthetic polymer such as polyesters, polyamides, phosphate esters or polymer that is formed from reactions comprising “ethylenically unsaturated monomers” that include substituted or unsubstituted ethylenically unsaturated monomer groups, vinyl groups, allyl groups, acryl groups, melamide groups, and acryloyl groups, and mixtures thereof. They could be formed from ethylenically unsaturated monomers of the general formula CHR═CXY, wherein R could be hydrogen or alkyl, X and Y may be hydrogen, alkyls, aryls, alkoxy, carboxylic acids, amides, acetamides, esters, ethers, and the like. Suitable examples include, but are not limited to, ethylene, propylene, butene-1, vinyl cyclohexane, styrene, vinyl toluene, ionizable monomers (such as 1-N,N-diethylaminoethylmethacrylate), diallyldimethylammonium chloride, 2-acrylamido-2-methyl propane sulfonate, and acrylic acid, and mixtures or derivatives thereof; allylic monomers (such as di-allyl phthalate, di-allyl maleate, allyl diglycol carbonate, and the like); vinyl formate, vinyl acetate, vinyl propionate, vinyl butyrate, crotonic acid, itaconic acid, vinyl fluoride, vinyl chloride, vinylidine fluoride, tetrafluoroethylene, acrylamide and its derivatives, methacrylamide, methacrylonitrile, acrolein, methyl vinyl ether, ethyl vinyl ether, vinyl ketone, ethyl vinyl ketone, allyl acetate, allyl propionate, and diethyl maleate; and diene monomers (such as butadiene, isoprene, and chloroprene, etc.); and mixtures or derivatives thereof. The polymer could also be a combination of the previously described polymer, either in the form of a random copolymer or a multi-block copolymer.

In all of the four embodiments, crosslinking consists of the attachment of two or more polymeric chains through the chemical association of such chains to a common element or chemical group. Suitable crosslinkers may comprise a chemical compound containing a polyvalent ion such as, but not necessarily limited to, boron, calcium, chromium, iron, aluminum, titanium, and zirconium. They may also comprise a reactive organic group in the form of a dielectrophile or dinucleophile system such as, but not necessarily limited to aldehydes or dialdehydes, diacids, anhydrides, acid chlorides, diamines, dinitriles, diols, dihalogenated compounds. In the fourth embodiment, the crosslinking activator could be a pH control agent that adjusts the pH to reach the optimum pH for polymer crosslinking.

In a second aspect of the present invention, there are provided compositions with an encapsulated agent, these compositions leading to polymer systems for drilling, completion or remedial operations in subterranean zones penetrated by a borehole by initiating polymerization with a polymerisable monomer and a polymerization initiator.

In a first embodiment, the system includes: a carrier fluid (C), an encapsulated polymerisable monomer (A) in the encapsulating material (B), a first reactive component being a polymerization initiator (R), a second reactive component being a crosslinker (R), and other additives, such as polymerization activator, pH control agent, delaying agent, fillers, fluid loss agents, lubricating agents, biocides and other relevant additives for the specific application the system is used for.

In a second embodiment, the system includes: a carrier fluid (C), a first reactive component (A) being a polymerisable monomer, an encapsulated polymerization initiator (A) in the encapsulating material (B), a second reactive component being a crosslinker (R), and other additives, such as polymerization activator, pH control agent, delaying agent, fillers, fluid loss agents, lubricating agents, biocides and other relevant additives for the specific application the system is used for.

In a third embodiment, the system includes: a carrier fluid (C), a first reactive component (A) being a polymerisable monomer, a second reactive component (A) being a polymerization initiator, a third reactive component being a crosslinker (A), an encapsulated polymerization activator (R) in the encapsulating material (B), and other additives, such as pH control agent, delaying agent, fillers, fluid loss agents, lubricating agents, biocides and other relevant additives for the specific application the system is used for.

In a fourth embodiment, the system includes: a carrier fluid (C), a combination of polymerisable monomer (A), polymerization initiator (A), crosslinker (R) or activator (R) encapsulated in a single or several capsules or solid matrix (B), and other additives, such as pH control agent, delaying agent, fillers, fluid loss agents, lubricating agents, biocides and other relevant additives for the specific application the system is used for.

In these embodiments, the base fluid can be water-based, solvent-based or oil-based. The polymerisable monomer could be a “ethylenically unsaturated monomers” that include substituted or unsubstituted ethylenically unsaturated monomer groups, vinyl groups, allyl groups, acryl groups, melamide groups, and acryloyl groups, and mixtures thereof. These ethylenically unsaturated monomers could be of the general formula CHR═CXY, wherein R could be hydrogen or alkyl, X and Y may be hydrogen, alkyls, aryls, alkoxy, carboxylic acids, amides, acetamides, esters, ethers, and the like. Suitable examples include, but are not limited to, ethylene, propylene, butene-1, vinyl cyclohexane, styrene, vinyl toluene, ionizable monomers (such as 1-N,N-diethylaminoethylmethacrylate), diallyldimethylammonium chloride, 2-acrylamido-2-methyl propane sulfonate, and acrylic acid, and mixtures or derivatives thereof; allylic monomers (such as di-allyl phthalate, di-allyl maleate, allyl diglycol carbonate, and the like); vinyl formate, vinyl acetate, vinyl propionate, vinyl butyrate, crotonic acid, itaconic acid, vinyl fluoride, vinyl chloride, vinylidine fluoride, tetrafluoroethylene, acrylamide and its derivatives, methacrylamide, methacrylonitrile, acrolein, methyl vinyl ether, ethyl vinyl ether, vinyl ketone, ethyl vinyl ketone, allyl acetate, allyl propionate, and diethyl maleate; and diene monomers (such as butadiene, isoprene, and chloroprene, etc.); and mixtures or derivatives thereof.

In all of the four embodiments, the selection of polymerization initiator will vary depending on the particular monomer that is used, and the compatibility of various monomers and initiators will be understood by those skilled in the art. Illustrative examples of polymerization initiators employable herein can include oxidizing agents, persulfates, peroxides, azo compounds such as 2,2′-azobis(2-amidinopropane)dihydro-chloride and oxidation-reduction systems.

The crosslinker may be a reactive organic group in the form of a dielectrophile or dinucleophile system such as, but not necessarily limited to aldehydes or dialdehydes, diacids, anhydrides, acid chlorides, diamines, dinitriles, diols, dihalogenated compounds. It also could be a di-ethylenically unsaturated monomer that react with the main monomer during polymerization to create crosslinking bridges between the main polymer chains. These di-ethylenically unsaturated crosslinking monomers could be of the general formula CHR═CLC═CHR′, wherein R and R′ could be hydrogen or alkyl and L could be any type of organic chain that links both unsaturated groups.

The polymerization activator could be an organometallic compound used as a redox activator, such as ion salts, copper salts, cobalt salts, zinc salts and the like; it could also be a radical trap that helps keeping the reaction on going as known in living polymerization techniques, such as amines, nitroxides, Prussian blue, disulfides, quinones and other activator/catalyst for polymerization reactions known by those skilled in the art.

In another aspect of the invention, the system includes: a carrier fluid (C), an encapsulated swelling clay (A) in the encapsulating material (B), and other additives, such as pH control agent, delaying agent, fillers, fluid loss agents, lubricating agents, biocides and other relevant additives for the specific application the system is used for. The swelling clay can be natural such as, but not limited to, montmorillonite, hectorite and derivatives or synthetic, such as laponite.

### EXAMPLES

The following examples serve to further illustrate the invention. The materials used in the examples are commonly available and used in the oilfield industry.

### Example 1

A system was made of an aqueous fluid containing 0.5 wt % of xanthan gum (J312 from Schlumberger) and 3 wt % of TYPE I solid. The type I solid was made of 17 wt % of lime surrounded by an encapsulating matrix of organopolysiloxane (37% silica; 46% oil and surfactant) with average diameter of 10 microns.

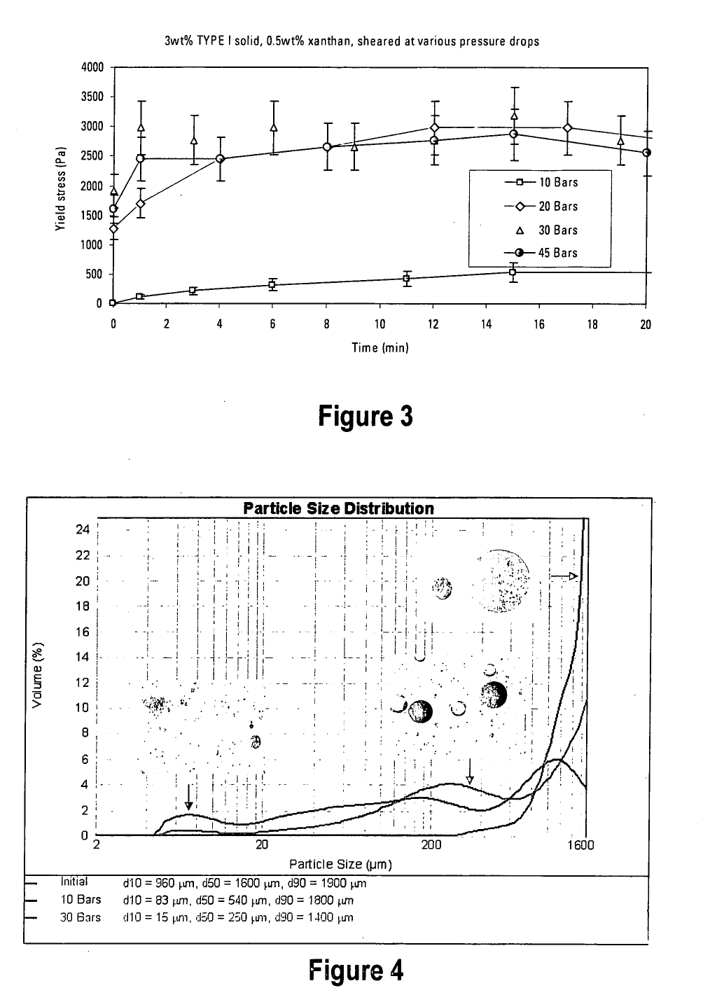

The fluid was pumped through a 2 mm restriction at various pressure drops which represent different degree of stress. The yield stress development was then recorded. The results are available on FIG. 3 which shows the yield stress behavior of the composition: at 10 bars, the material was not broken by the stress significantly, as such, very little yield stress was observed. Once the pressure drops exceeded 20 bars, full yield stress development was recorded

### Example 2

A system was made of 1 wt % of the TYPE II material that was slurried in an aqueous fluid containing 0.5 wt % of xanthan gum (J312 from Schlumberger) and then stressed at 10 and 30 bars. The Type II material was ISP Captivates® with 0.3% of Red 30 dye dispersed in shea butter encapsulated by 2-4 wt % of a wall phase containing 50% of gelatin and 50% of gum arabic (acacia Senegal gum) with average diameter of 1500 microns

The results were monitored on a particle sizer, which showed breaking of this material under stress. The results are available from FIG. 4 which shows the particle size distribution on a Type II system. The x-axis is particle size, and y-axis is percentages. The appearance of smaller particles under 30 bars indicates that the original larger particles were disintegrated and thus resulted into smaller fragments.

### Example 3

A fluid was made of 2 wt % of the Type II material with 0.5 wt % of D167 gelling agent (available from Schlumberger) and slurried in a tank under paddle stirring. The type II material was ISP Microcapsules® 10003 with 3.5% of ultramarine blue dye and 1.5% of TiO₂ dispersed in 2-phenylethyl ester of Benzoic acid encapsulated by 2-4 wt % of a wall phase containing 50% of gelatin and 50% of gum arabic (acacia Senegal gum), with an average diameter of 1300 microns.

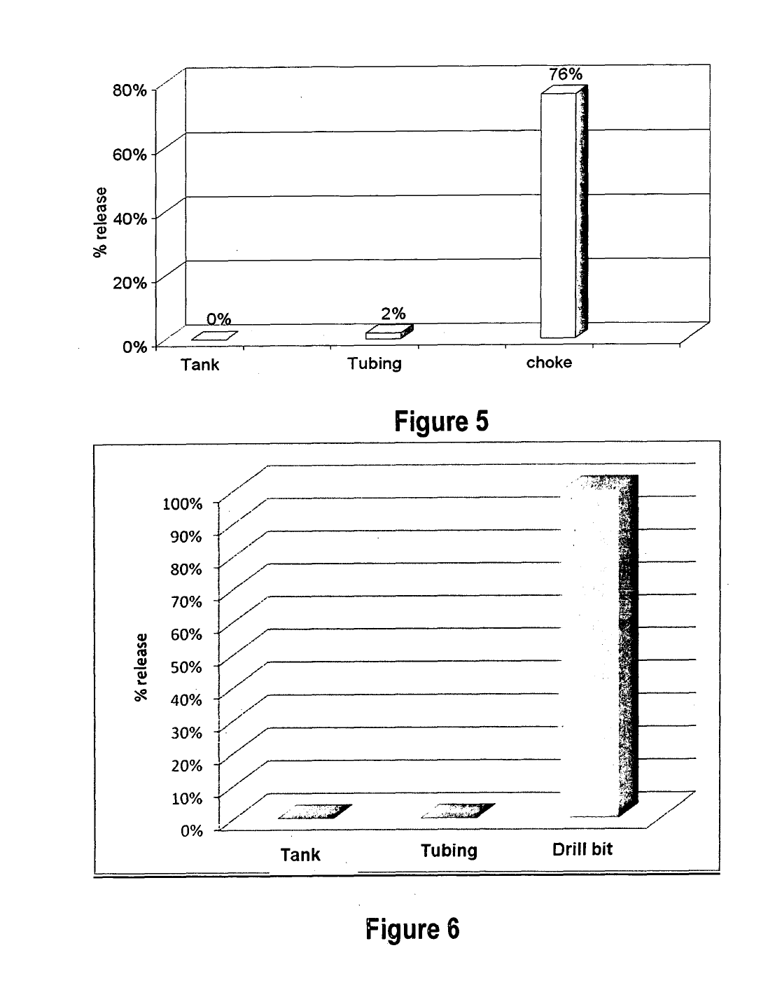

A sample was collected that indicated 0% of release. The fluid was pumped at 80 L/min through a centrifugal pump and a triplex reciprocating pump: after that, another sample was collected and only 2% of release was measured. Then the fluid was circulated through a choke creating a pressure drop of 30 bars. FIG. 5 shows the release measurement of the first two samples as compared to the release of the system under pressure drop of 30 bars that is significant with 76% of reactive component (A) released. This indicates that, in these conditions, most of the release is triggered through the choke. Release was measured by chemical extraction of the active component in the external fluid and is expressed as molar percentage as a function of the initial molar concentration of active ingredient.

### Example 4

A fluid was made of 2 wt % of the Type I material with 0.5 wt % of xanthan gum (J312 from Schlumberger), slurried in a tank under paddle stirring. The capsule wall was made of polyurethane, and the core material was a 50% PEI (Poly(ethyleneimine)) aqueous solution. The size of the capsule ranges from 50 to 4000 microns, and the volume ratio of the internal component is 5 to 80% as supposed to the capsule volume.

A sample was collected in the tank that indicated 0% of release. The fluid was pumped at 218 L/min through a centrifugal pump and a Triplex reciprocating pump: after that, another sample (tubing) was collected and no detectable release was observed. Then the fluid was pumped through a drill bit nozzle creating a pressure drop of 70 bars. FIG. 6 shows the release measurement of the first two samples as compared to the release of the system under pressure drop of 70 bars that is significant with 100% of reactive component (A) released. This indicates that, in these conditions, all the release is triggered through the drill bit nozzle. Release was measured by examining the integrity of the capsules under microscope.

1. A composition comprising an encapsulating material (B) and a component (A), wherein said component (A) is trapped within said encapsulating material (B), the system further comprising a carrier fluid (C) transporting said encapsulating material (B) and said trapped component (A), wherein said encapsulating material (B) is able to break and releases said component (A) when submitted to sufficient stress.

2. The composition of claim 1, further comprising a reactive component (R) present in said carrier fluid (C).

3. The composition according to claim 1, wherein the encapsulating material (B) is a solid matrix made of inert material for component (A).

4. The composition according to claim 1, wherein the encapsulating material (B) is a capsule made of an inert wall material for component (A).

5. A method to release a component (A) in a zone of a wellbore or near-wellbore, comprising the steps of:
placing a encapsulating material (B) and a component (A) in the wellbore, wherein said component (A) is trapped within said encapsulating material (B);
placing said encapsulating material (B) and said trapped component (A) in a restriction in the vicinity of the zone so said encapsulating material (B) is able to break and releases said component (A).

6. The method of claim 5, wherein the step of placing said encapsulating material (B) is done by placing further a carrier fluid (C) transporting said encapsulating material (B) and said trapped component (A).

7. The method of claim 5, wherein said restriction creates sufficient stress to break the encapsulating material (B).

8. The method of claim 6, wherein said restriction creates sufficient stress to break the encapsulating material (B).

9. A method for treating loss circulation comprising
mixing a carrier fluid (C) with a component (A) being encapsulated into an encapsulation material (B) to form a pumpable slurry;
pumping said slurry into a wellbore through at least one casing until the slurry passes through a restriction;
Wherein said restriction creates sufficient stress to break the encapsulation material (B) thereby releasing the component (A).

10. The method of claim 9, wherein the restriction creates velocity increases or decreases of at least 50 times variation.

11. The method of claim 9, wherein the restriction is a drill bit nozzle that provoke a pressure drop of from about 150 to 5 000 psi when the slurry is passing through it.

12. The method of claim 9, wherein the encapsulating material (B) is a flexible capsule comprising gelatin, pectin, derivatives of cellulose, arabic gum, guar gum, locust bean gum, tara gum, cassia gum, agar, or n-octenyl succinated starch, porous starch, pectin, alginates, carraghenanes, xanthan, chitosan, scleroglucan, diutan and mixtures thereof.

13. The method of claim 9, wherein the component (A) is inert to the encapsulation material (B).

14. The method of claim 9, wherein the carrier fluid further comprises a reactive component (R).

15. The method of claim 9, wherein the reactive component (R) is inert to the encapsulation material (B).

16. The method of claim 9, wherein the carrier fluid is chosen from the group consisting of water-based fluids, solvent-based fluids or oil-based fluids and mixtures thereof.

17. The method of claim 9, wherein the component (A) comprises a polysaccharide such as guar and its derivatives, cellulose and its derivatives, xanthan, wellan, scleroglucan, chitosan, diutan, a synthetic polymer such as polyesters, polyamides, phosphate esters or polymer that is formed from reactions comprising “ethylenically unsaturated monomers” that include substituted or unsubstituted ethylenically unsaturated monomer groups, vinyl groups, allyl groups, acryl groups, melamide groups, and acryloyl groups, and mixtures thereof. They could be formed from ethylenically unsaturated monomers of the general formula CHR═CXY, wherein R could be hydrogen or alkyl, X and Y may be hydrogen, alkyls, aryls, alkoxy, carboxylic acids, amides, acetamides, esters, ethers, and the like. Suitable examples include, but are not limited to, ethylene, propylene, butene-1, vinyl cyclohexane, styrene, vinyl toluene, ionizable monomers (such as 1-N,N-diethylaminoethylmethacrylate), diallyldimethylammonium chloride, 2-acrylamido-2-methyl propane sulfonate, and acrylic acid, and mixtures or derivatives thereof; allylic monomers (such as di-allyl phthalate, di-allyl maleate, allyl diglycol carbonate, and the like); vinyl formate, vinyl acetate, vinyl propionate, vinyl butyrate, crotonic acid, itaconic acid, vinyl fluoride, vinyl chloride, vinylidine fluoride, tetrafluoroethylene, acrylamide and its derivatives, methacrylamide, methacrylonitrile, acrolein, methyl vinyl ether, ethyl vinyl ether, vinyl ketone, ethyl vinyl ketone, allyl acetate, allyl propionate, and diethyl maleate; and diene monomers (such as butadiene, isoprene, and chloroprene, etc.); and mixtures or derivatives thereof.

18. The method of claim 14, wherein the reactive component (R) is a crosslinker.

19. The method of claim 18, wherein the crosslinker comprises crosslinkers a chemical compound containing a polyvalent ion such as boron, calcium, chromium, iron, aluminum, titanium, and zirconium; or a reactive organic group in the form of a dielectrophile or dinucleophile system such as aldehydes or dialdehydes, diacids, anhydrides, acid chlorides, diamines, dinitriles, diols, dihalogenated compounds; and mixtures thereof.

20. The method of claim 9, wherein the slurry further comprises pH control agent, delaying agent, fillers, fluid loss agents, lubricating agents, or biocides and mixtures thereof.
